(19) United States
(12) Patent Application Publication
(10) Pub. No.: US 2011/0191426 A1
(43) Pub. Date: Aug. 4, 2011

(54) Communication technique

(76) Inventor: Aron Leifer, Brooklyn, NY (US)

(21) Appl. No.: 12/698,271

(22) Filed: Feb. 2, 2010

(51) Int. Cl. G06F 15/16; H04W 4/00

(52) U.S. Cl. 709/206; 455/466

(57) ABSTRACT

A venue provides one or more stickers or other visible indicia to one or more users of mobile devices, each of the one or more stickers bearing a identification number (“ID number”). A first user at the venue may register a mobile device at a server operated by a messaging service provider. Upon viewing a sticker worn by a second user at the venue, the first user may utilize the second user's ID number to cause a Short Message Service (“SMS”) text message or other content to be transmitted to the second user's mobile device via the server. The first user and the second user may thereby communicate via SMS messages without knowledge of each other's telephone numbers, and regardless of which wireless communication service providers the first user and the second user have adopted.

### BACKGROUND

Individuals who congregate at venues such as bars, restaurants, and nightclubs frequently enjoy communicating with one another through the exchange of text messages via smartphones and other mobile devices. However, those who wish to send SMS messages have been required to know which wireless carrier the desired recipient is using, because the portability of telephone numbers associated with mobile devices has presented obstacles to the inter-carrier exchange of SMS messages. Moreover, many individuals find it difficult to approach strangers with whom they would like to communicate.

An adequate technique for overcoming social anxieties and for facilitating the exchange of SMS messages without requiring each sender to know which wireless carrier each desired recipient is using has eluded those skilled in the art, until now.

### SUMMARY

The present invention provides a method for the creation of a temporary social network at a venue to facilitate the exchange of SMS messages between one or more mobile devices associated with one or more wireless carriers, and a system and product for its implementation.

### BRIEF DESCRIPTION OF THE DRAWINGS

FIG. 1 illustrates by way of a block diagram one embodiment of a communication method, product, and system.

FIG. 2 is a diagram of one implementation of sticker 106 introduced in conjunction with FIG. 1.

FIG. 3 illustrates by way of a block diagram an embodiment of a mobile device.

FIGS. 4A through 4L illustrate representative implementations of web pages 118 introduced in conjunction with FIG. 1.

FIG. 5A illustrates one implementation of user data table 121 introduced in conjunction with FIG. 1.

FIG. 5B illustrates one implementation of venue data table 122 introduced in conjunction with FIG. 1.

FIGS. 6A and 6B illustrate representative implementations of SMS 105 messages introduced in conjunction with FIG. 1.

FIG. 7 is a functional block diagram illustrating in greater detail one implementation of the server 111 introduced in conjunction with FIG. 1.

FIG. 8 illustrates by way of an operational flow diagram another embodiment of the present invention for a communication method, product, and system.

FIG. 9 illustrates by way of an operational flow diagram still another embodiment of the present invention for a communication method, product, and system.

FIG. 10 illustrates by way of an operational flow diagram still another further embodiment of the present invention for a communication method, product, and system.

### DETAILED DESCRIPTION

In the following discussion, many specific details are provided to set forth a thorough understanding of the present invention. It will be obvious, however, to those skilled in the art that the present invention may be practiced without the explicit disclosure of some specific details, and in some instances of this discussion with reference to the drawings, known elements have not been illustrated in order to not obscure the present invention in unnecessary detail. Such details concerning computer networking, software programming, telecommunications and the like may at times not be specifically illustrated as such are not considered necessary to obtain a complete understanding of the core present invention, but are considered present nevertheless as such are considered to be within the skills of persons of ordinary skill in the art.

It is also noted that, unless indicated otherwise, all functions described herein may be performed in hardware, software, firmware, or some combination thereof. In some embodiments the functions may be performed by a processor, such as a computer or an electronic data processor, in accordance with code, such as computer program code, software, and/or integrated circuits that are coded to perform such functions. Those skilled in the art will recognize that software, including computer-executable instructions, for implementing the functionalities of the present invention may be stored on a variety of computer-readable media including hard drives, compact disks, digital video disks, integrated memory storage devices and the like.

Furthermore, the following discussion is for illustrative purposes only, and discusses the present invention in reference to various embodiments which may perhaps be best utilized subject to the desires and subjective preferences of various users. One of ordinary skill in the art will, however, appreciate that the present invention may be utilized in a great variety of forms in social environments of any type. Unless explicitly stated, the method embodiments described herein are not constrained to a particular order or sequence. Additionally, some of the described method embodiments or elements thereof can occur or be performed at the same point in time.

The various embodiments described herein are directed to a method, system, and product for facilitating communication between one or more users of mobile devices at a venue. Briefly stated, the present embodiment allows a venue to provide one or more stickers or other visible indicia to one or more users of mobile devices. Each of the one or more stickers may bear an identification number (“ID number”) or other visible indicia which uniquely identifies the user who wears that sticker at the venue. Each ID number may further be capable of being used to address one or more communications to a mobile device associated with the user who wears that sticker.

A first user at the venue may register a mobile device at a server operated by a messaging service provider. Upon viewing a sticker worn by a second user at the venue, the first user may utilize the second user's ID number to cause a Short Message Service (“SMS”) message to be transmitted to the second user's mobile device. The present embodiment allows the first user and the second user to communicate via SMS messages without knowledge of each other's telephone numbers, and regardless of which wireless communication service providers (“wireless carriers”) the first user and the second user have adopted. Reference to a first user sending a SMS message to a second user, as discussed herein, refers to the communication of the first user's mobile device via the Internet or other communication network with a remote server which causes a SMS message to be transmitted to the second user's mobile device.

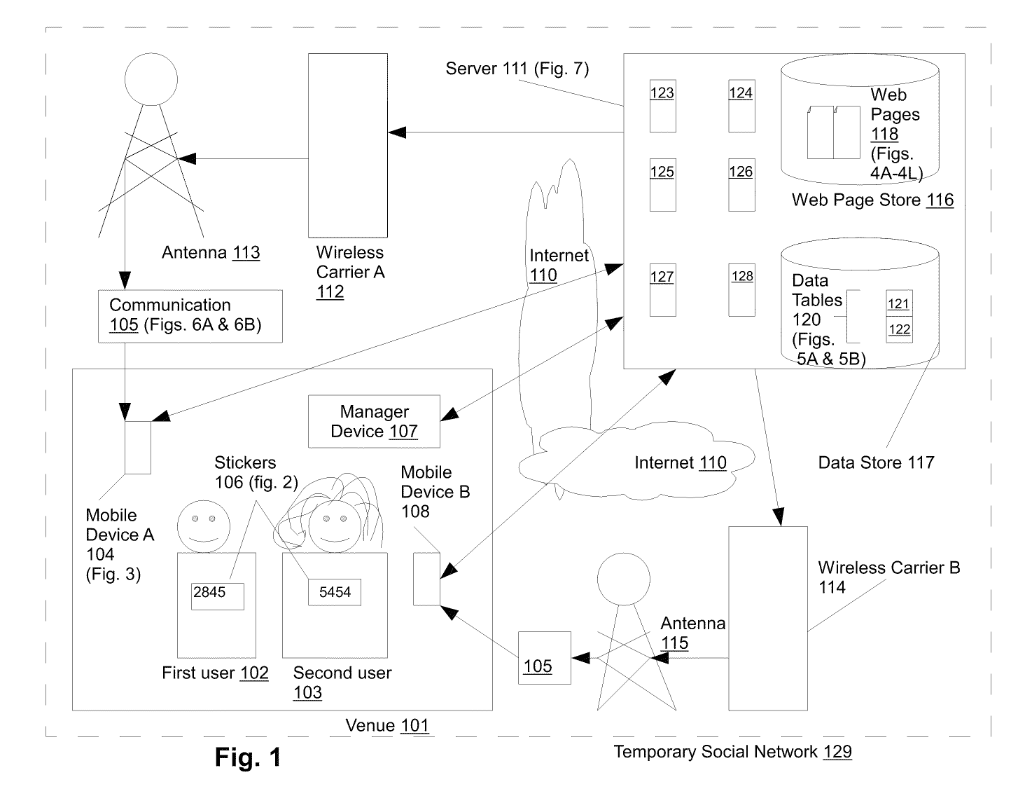

Turning now to FIG. 1, there is illustrated in the form of a block diagram one embodiment of a communication method, product, and system. It is contemplated that the present embodiment allows a messaging service provider to create a temporary, duration-limited social network 129 at a venue 101. “Temporary social network” as used in connection with one embodiment refers to a duration-limited social network which facilitates the exchange of one or more communications between one or more mobile devices associated with one or more wireless carriers. “Temporary social network” as used in connection with another embodiment refers to a duration-limited social network which facilitates the exchange of one or more communications between one or more mobile devices associated with one or more wireless carriers, through the use of ID numbers displayed on stickers or other visible indicia worn by one or more users at a venue, each ID number capable of identifying a user at the venue and further capable of being used to address a communication to a mobile device associated with the identified user. In one implementation, “communication” means a SMS message, Multimedia Service (“MMS”) message, or Enhanced Messaging Service (“EMS”) message. In another implementation, “communication” means any text, images, video files, or other data which may be transmitted electronically.

The messaging service provider may provide one or more stickers 106 to venue 101, which venue 101 distributes to one or more users (such as first user 102 and second user 103) of one or more mobile devices (such as mobile device A 104 and mobile device B 108) at venue 101. Server 111 is configured, as described herein, to facilitate the exchange of one or more communications 105 between one or more mobile devices (such as mobile device A 104 and mobile device B 108) at venue 101 during the existence of temporary social network 129, which one or more mobile devices are associated with one or more wireless carriers. A first user 102 may register mobile device A 104 with server 111 by transmitting to server 111 the ID number and/or other data provided on first user 102's sticker 106. Subsequently, first user 102 may transmit content to server 111 along with data provided on second user 103's sticker 106, thereby causing server 111 to transmit a communication 105 to second user 103's mobile device B 108. “Content” may refer to text, one or more images, one or more video files, or any other content which may be transmitted electronically.

In one embodiment, temporary social network 129 is limited in duration—for example and without limitation, the data provided on one or more stickers 106 may permit one or more users (such as first user 102 and second user 102) to exchange communications 105 for a period of only fifteen hours. In another aspect, server 111 may be configured to allow the data provided on one or more stickers 106 to be used permanently for the exchange of one or more communications 105 via server 111.

Any type of mobile device, whether conventional or non-conventional, may be adapted for use in the present embodiment, including but not limited to smartphones, laptop computers, Internet tablets, pagers, PDAs, cellular telephones, or any other device capable of transmitting and receiving messages. Further, this embodiment is contemplated for use with any communication network, including but not limited to the Internet, one or more mobile communication networks utilizing GSM standards or any other telecommunication standards, or any other network which allows messages to be transmitted to and received from one or more mobile devices.

In FIG. 1, first user 102 and second user 103 are present at venue 101. By way of example but without limitation, venue 101 may be a nightclub, a restaurant, a bar, a convention center, or any other location in which one or more individuals are present. In the present embodiment, the manager of venue 101 has provided stickers 106 to each of first user 101 and second user 102. “Manager” as used herein may refer to the venue's owner, employee, agent, or anyone else with authority to provide one or more stickers 106 to one or more individuals in venue 101. As an alternative to one or more stickers 106, the manager may distribute one or more buttons, badges, T-shirts, or any other visible indicia capable of displaying an ID number. In the embodiment shown, each sticker 106 bears a visible ID number.

Each of first user 102 and second user 103 has a mobile device. In FIG. 1, these mobile devices are labeled mobile device A 104 and mobile device B 108 to indicate that mobile device A 104 is associated with first user 102 and mobile device B 108 is associated with second user 103. Both mobile device A 104 and mobile device B 108 are capable of communicating with server 111 via the Internet 110. Mobile device A 104 is capable of receiving one or more messages from wireless carrier A 112 via antenna 113. In the embodiment shown, mobile device B 108 is capable of receiving one or more messages from wireless carrier B 114 via antenna 115. In this embodiment, wireless carrier A 112 and wireless carrier B 114 are different—for example, wireless carrier A 112 may be Verizon Wireless and wireless carrier B 114 may be AT&T. Alternatively, mobile device A 104 and mobile device B 108 may be capable of receiving one or more messages from the same wireless carrier, in which case wireless carrier A 112 and wireless carrier B 114 could refer to a single wireless carrier capable of transmitting one or more messages to both mobile device A 104 and mobile device B 108.

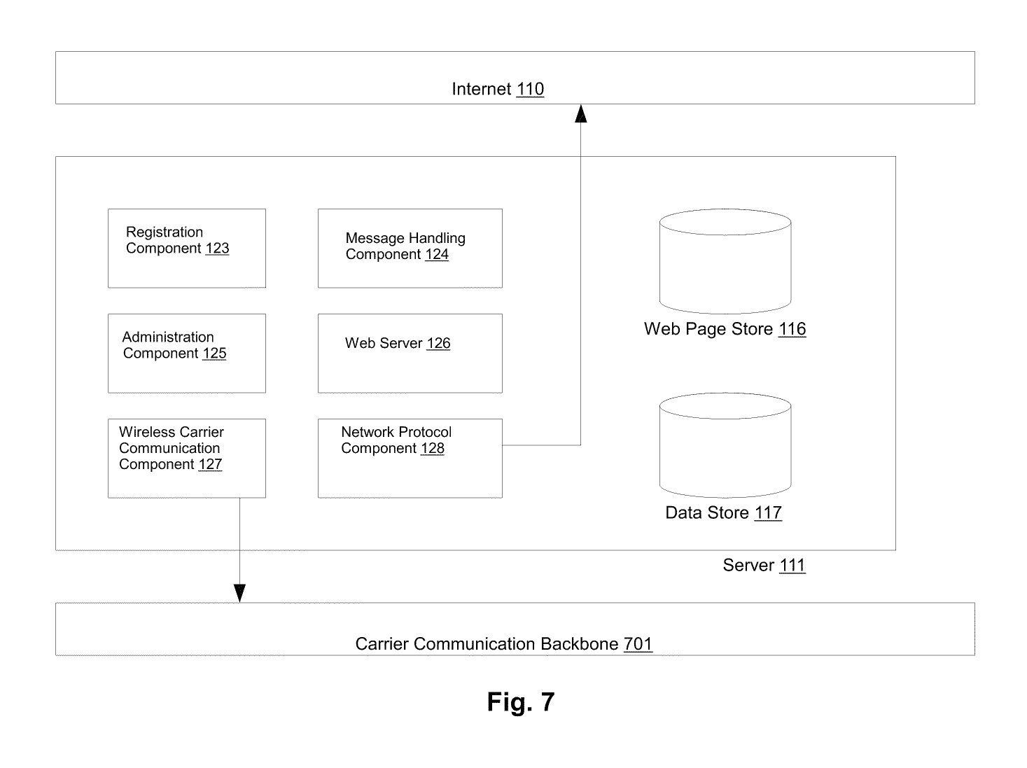

In the embodiment shown, server 111 is operated by a messaging service provider which facilitates the exchange of one or more communications 105 between one or more mobile devices (such as mobile device A 104 and mobile device B 108) at venue 101. Server 111 may be any combination of computer hardware, firmware, and/or software which is capable of storing and executing data. In the embodiment shown in FIG. 1, server 111 is capable of communicating with one or more mobile devices and at least one wireless carrier. (Server 111 is more fully described in FIG. 7 below.) In the embodiment shown in FIG. 1, server 111 is capable of communicating with at least wireless carrier A 112 and wireless carrier B 114.

In another embodiment, the features, functions, and operations of server 111 are distributed over two or more items of computing hardware, software, and/or firmware.

In the embodiment shown, server 111 includes web page store 116 and data store 117. Alternatively, web page store 116 and/or data store 117 may be located away from server 111. It is contemplated that server 111 is in communication with web page store 116 and data store 117 regardless of whether or not web page store 116 and/or data store 117 are resident on server 111. It is further contemplated that web page store 116 and data store 117 may be present on the same data storage medium or media.

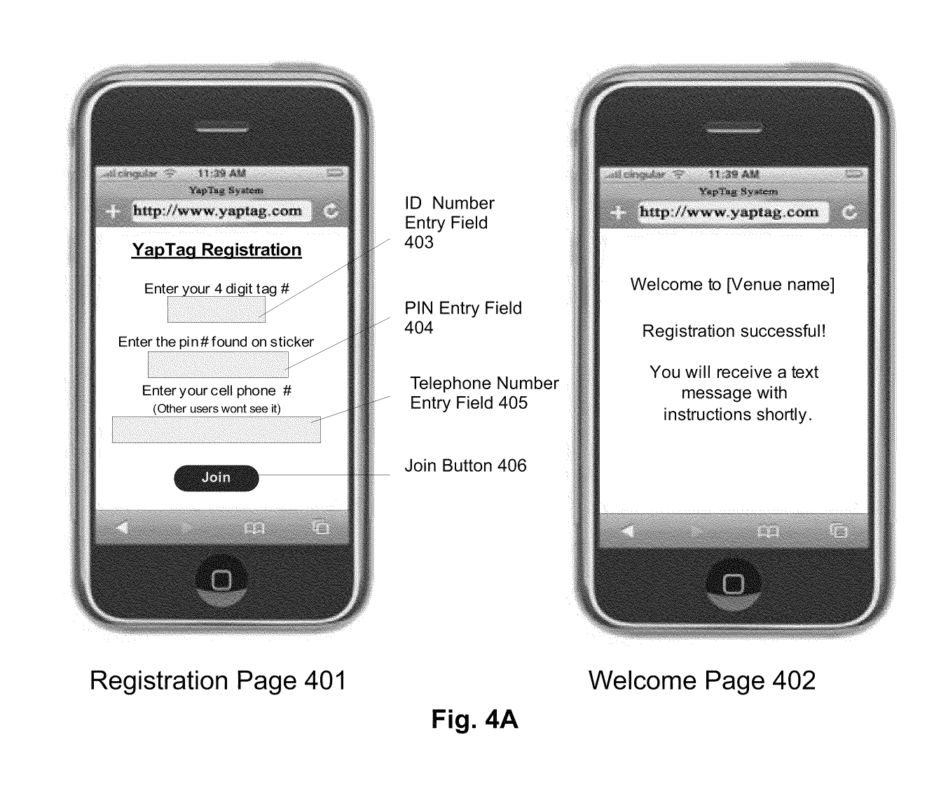

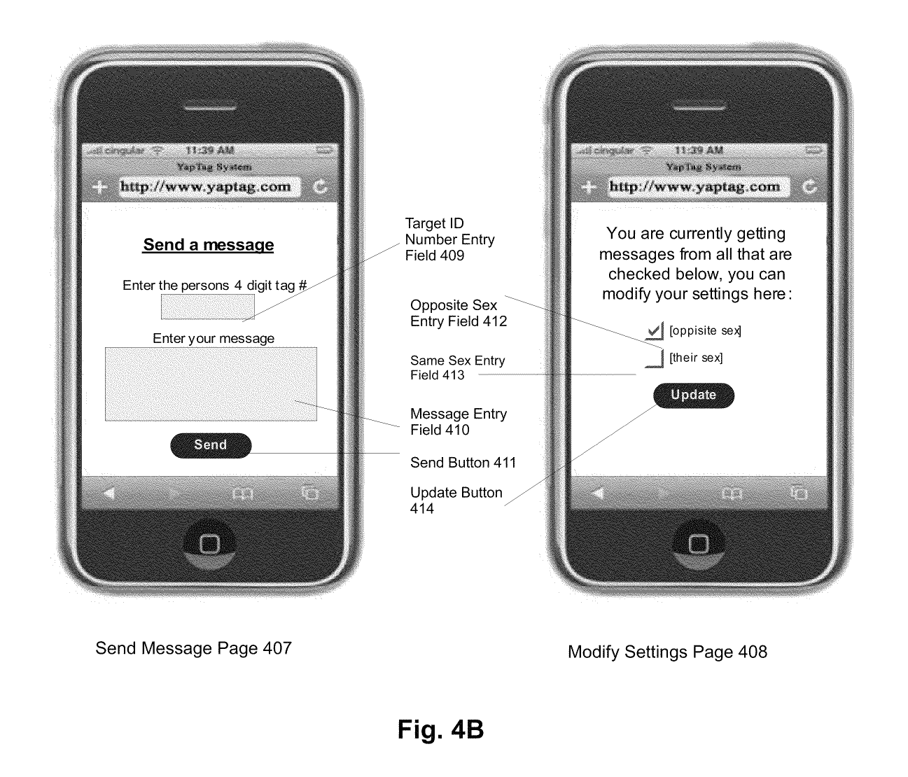

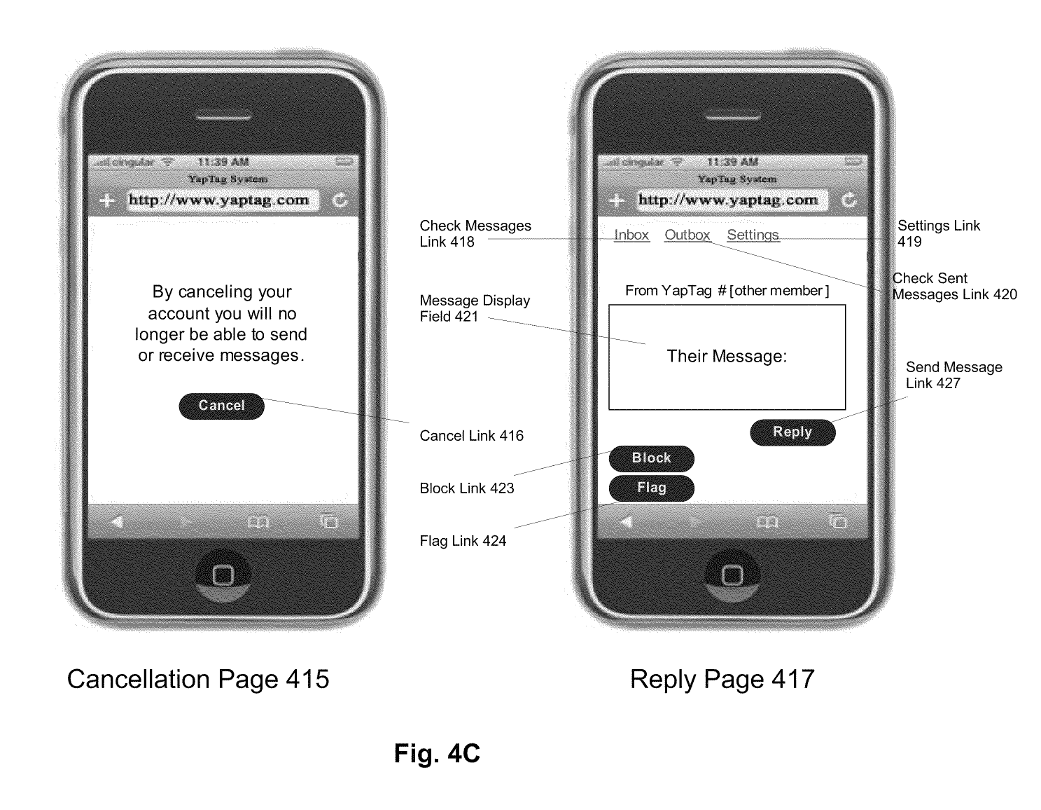

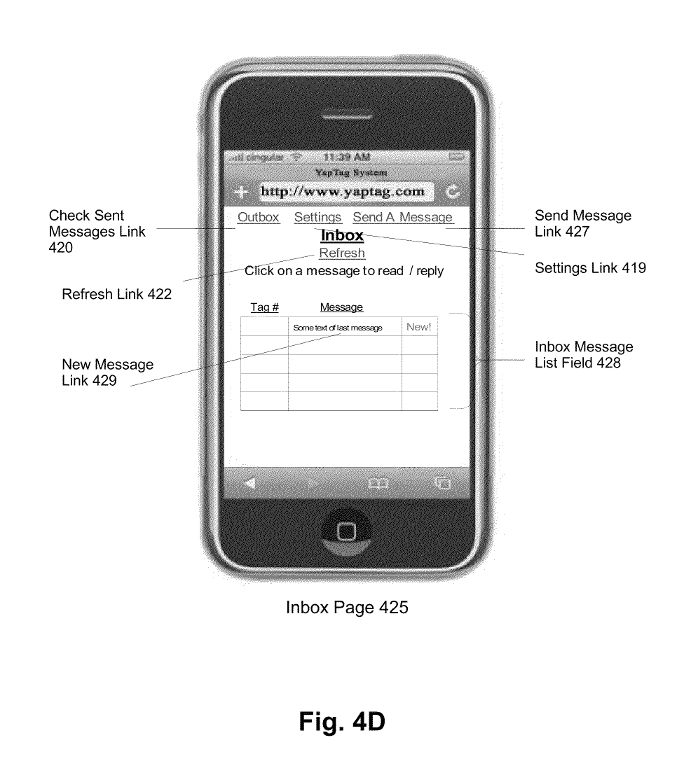

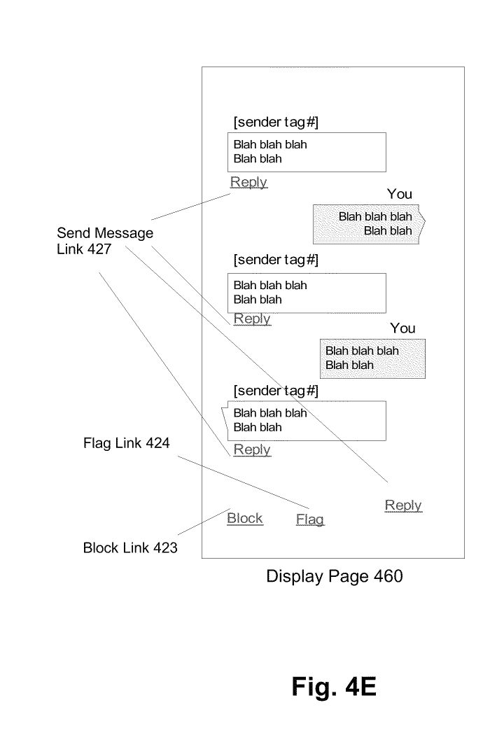

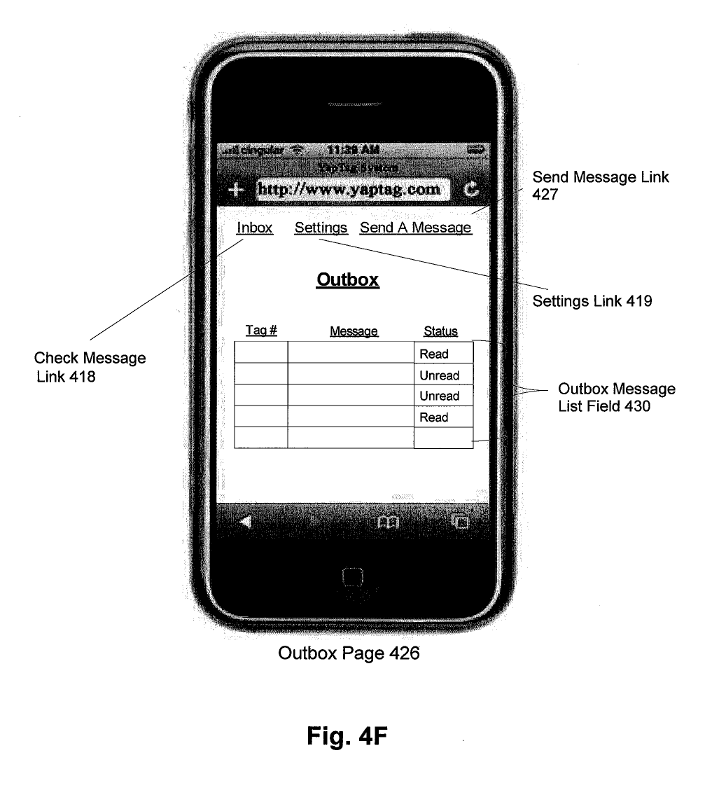

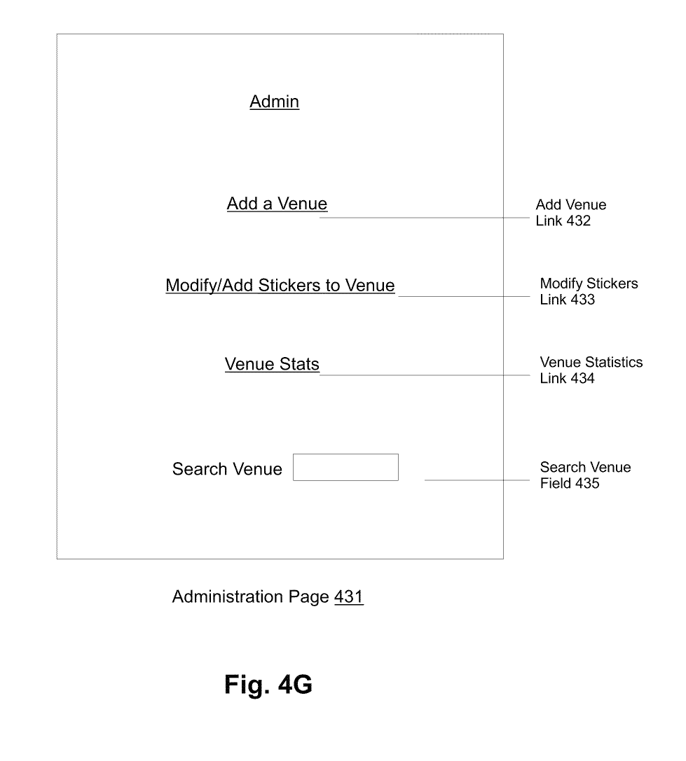

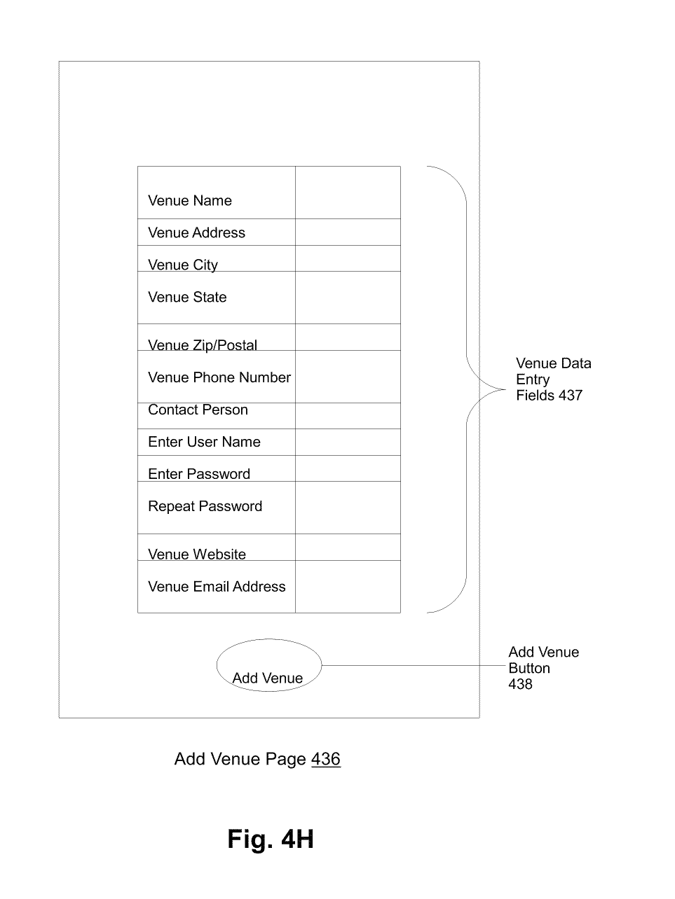

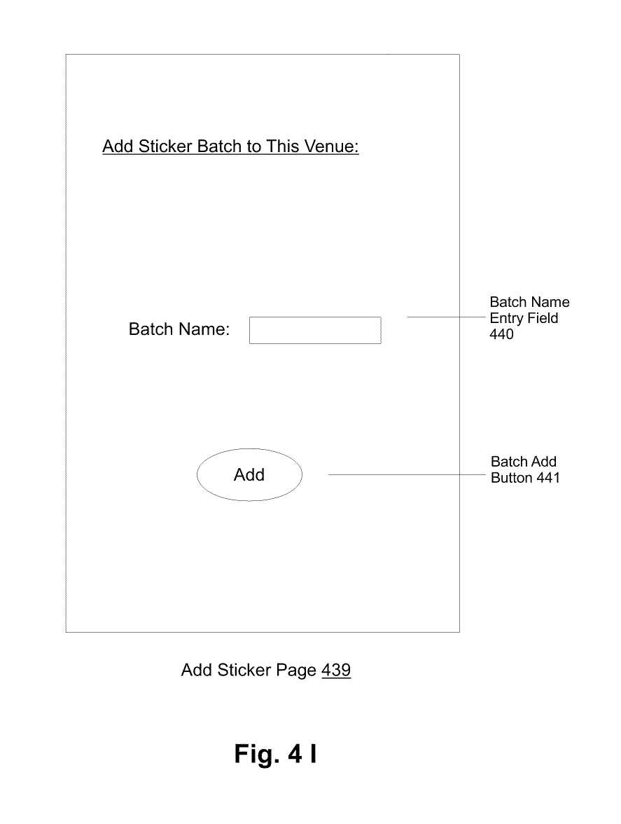

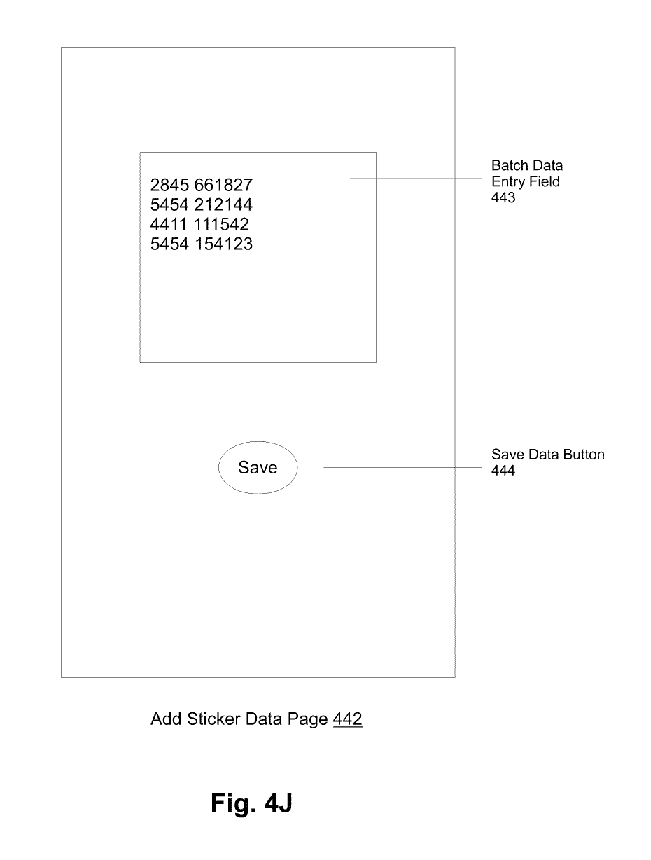

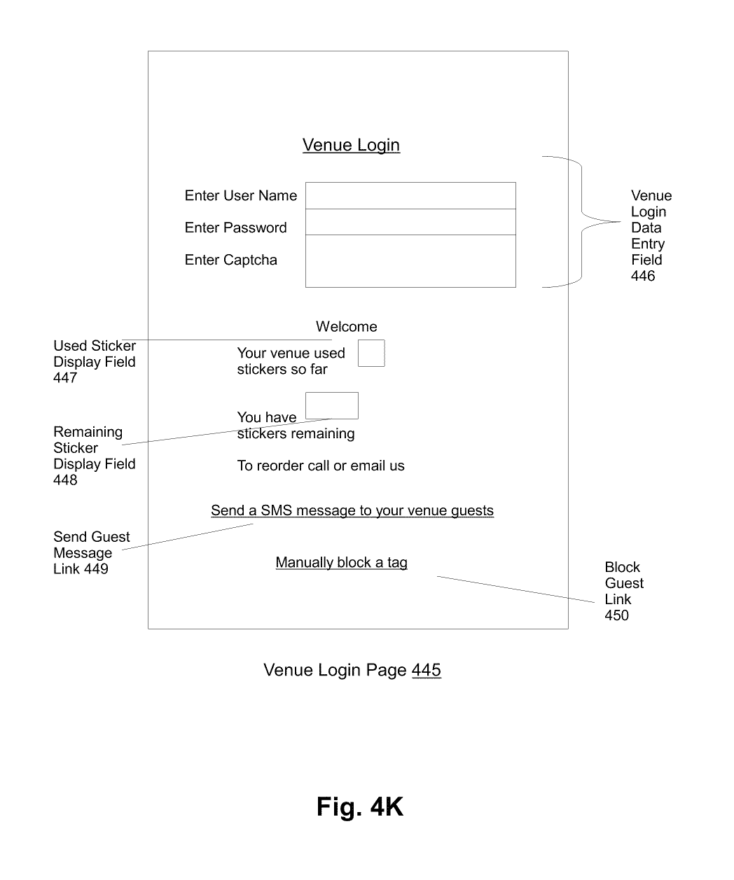

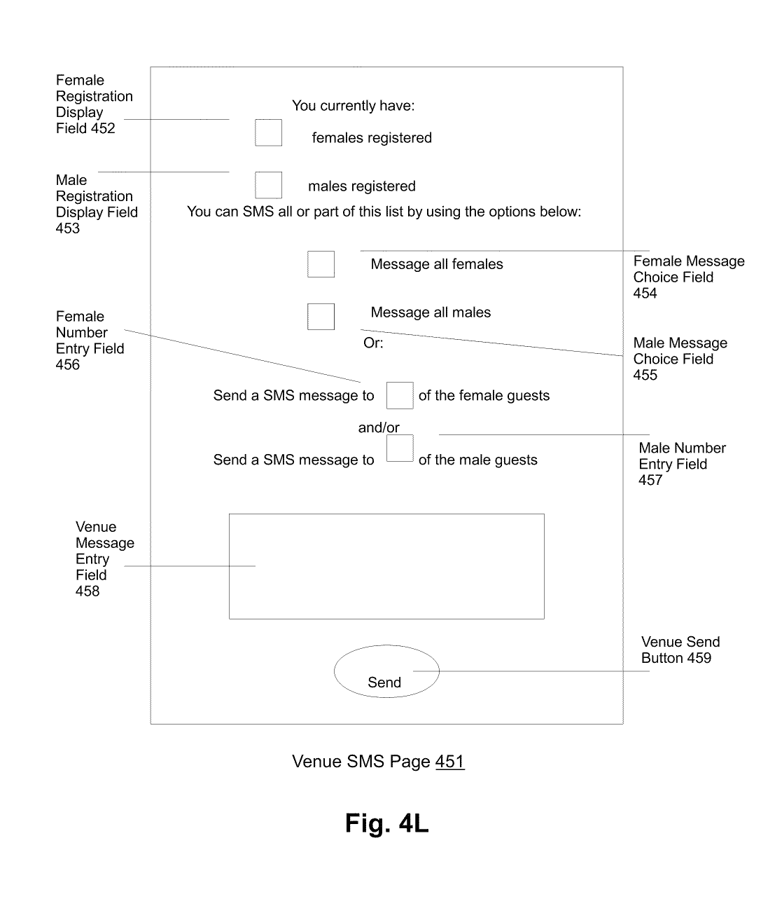

Web page store 116 may comprise, for example and without limitation, volatile and persistent (i.e., non-volatile) media for data storage such as computer-readable instructions or data structures, including but not limited to DVD or other optical storage, RAM, ROM, flash memory, or any other medium which can be used to store information and can be accessed by server 111. Web pages 118 are stored at web page store 116 and are more fully described in FIGS. 4A through 4L below. Each of web pages 118 comprises content, which content may take the form of text, non-textual information, or any other data which may be rendered in a web browser accessible via a mobile device (such as mobile device A 104 or mobile device B 108).

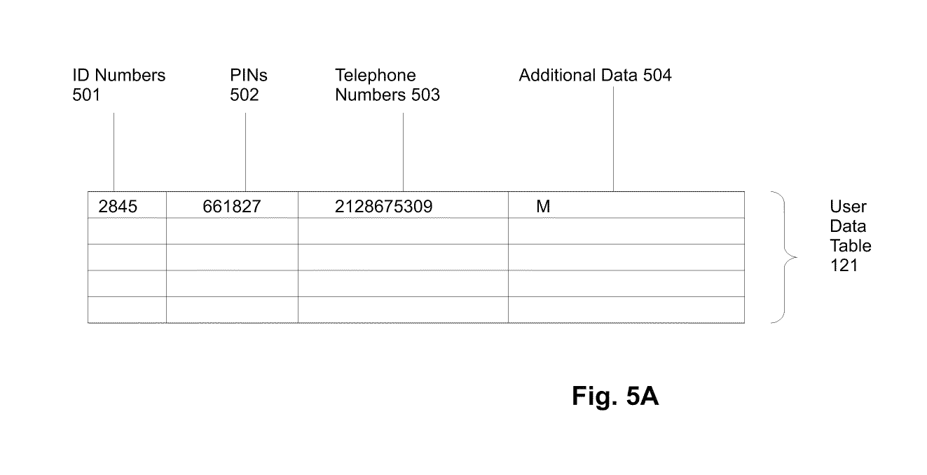

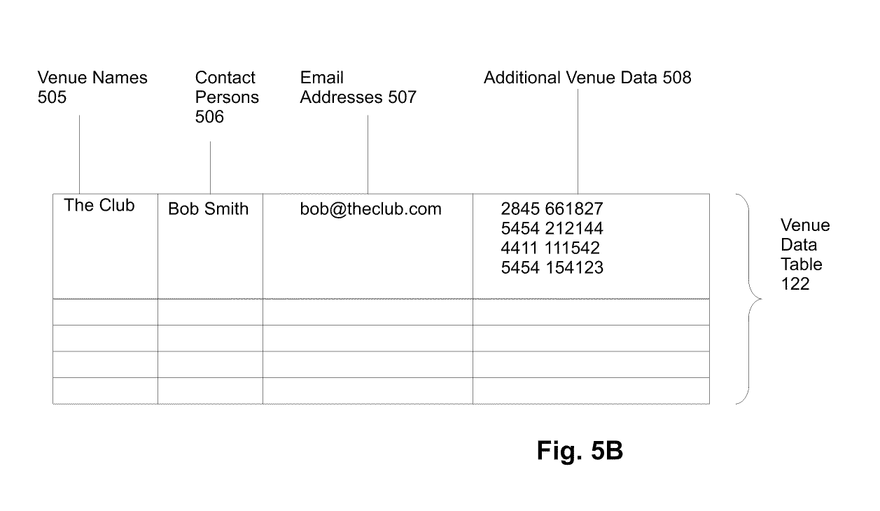

Data store 117 may comprise, for example and without limitation, volatile and persistent (i.e., non-volatile) media for data storage such as computer-readable instructions or data structures, including but not limited to DVD or other optical storage, RAM, ROM, flash memory, or any other medium which can be used to store information and can be accessed by server 111. In the embodiment shown, data tables 120 are stored at data store 117. Data tables 120 include user data table 121 and venue data table 122. Data tables 120 are more fully described in FIGS. 5A and 5B below.

In the embodiment shown in FIG. 1, server 111 further includes registration component 123. It is contemplated that one embodiment allows a messaging service provider to create a temporary social network 129 at a venue 101 through the delivery of one or more stickers 106 to venue 101 and the registration of venue 101 at server 111 via registration component 123.

In the embodiment shown, after the creation of temporary social network 129, registration component 123 receives user registration data from one or more mobile devices (such as mobile device A 104) associated with one or more individuals at venue 101 (such as first user 102) who wish to use the present embodiment to register their one or more mobile devices with the temporary social network 129 at server 111, which registration enables the exchange of communications 105 with other mobile devices (such as mobile device B 108) associated with individuals at venue 101 (such as second user 103). (Each individual at a venue 101 who has received one of stickers 106 in connection with a temporary social network 129 and is visibly wearing that sticker is referred to herein as a “user” regardless of whether that individual has completed the registration process.) “User registration data” refers to the data required by registration component 123 to cause the mobile device (for example, mobile device A 104) associated with a user (for example, first user 102) to become registered with a temporary social network 129 via server 111. User registration data may include, but is not limited to any or all of the following: an ID number, a PIN number, one or more telephone numbers, a name, one or more email addresses, one or more postal addresses, gender identification (i.e., male or female), and gender of interest. After a user (such as first user 102) transmits user registration data to server 111 via a mobile device (such as mobile device A 104), registration component 123 stores the user registration data in user data table 121.

Registration component 123 further receives venue registration data from one or more venues in connection with the present embodiment. “Venue registration data” for a venue 101 refers to the data required by registration component 123 to cause venue 101 to become registered with a temporary social network 129 via server 111. Venue registration data may include, but is not limited to, any or all of the following: a venue name, one or more email addresses, one or more contact names, one or more postal addresses, one or more telephone numbers, and data pertaining to one or more stickers 106 associated with the particular venue. As shown in FIG. 1, a manager device 107 is present at venue 101. Manager device 107 may be a cell phone, PDA, laptop, or any other device capable of connecting to the Internet. Manager device 107 may be used to transmit data to, and receive data from, server 111 in connection with the present embodiment. Registration component 123 may store the venue registration data received from one or more venue managers in venue data table 122. In another aspect, an administrator of a messaging service provider may add venue registration data directly to venue data table 122.

As shown in FIG. 1, server 111 further includes message handling component 124. Upon the occurrence of certain events more fully described below, message handling component 124 generates a communication 105 and causes the communication 105 (for example, the communication 105 directed to mobile device B 108 as illustrated in FIG. 1) to be transmitted to one or more mobile devices via one or more wireless carriers. “Generates” may refer to the creation of a new communication 105, the retrieval of a communication 105 from data storage, or any other process whereby a communication 105 may be produced. It is contemplated that the present embodiment may be used to transmit SMS content, Multimedia Service (“MMS”) content, Enhanced Messaging Service (“EMS”) content, or any other content capable of being transmitted to a mobile device.

The present embodiment further contemplates the transmission and/or receipt of one or more communications 105 from server 111 to one or more mobile devices (in one example, to mobile device A 104) via any network which is capable of transmitting and/or receiving one or more communications 105 from server 111 to one or more mobile devices. For example and without limitation, a communication 105 may be sent to mobile device A 104 using one or more SMS centers (“SMSC”) or MMS centers (“MMSC”) that provide gateway interfacing with respect to a cellular telephone network associated with wireless carrier A 112. Alternatively, a communication 105 may be sent to mobile device A 104 directly from server 111 via one or more SMSCs or MMSCs. In another aspect, a communication 105 may be sent to mobile device A 104 from server 111 via a next generation network (NGN).

In the embodiment shown, message handling component 124 communicates with wireless carrier A 112 and wireless carrier B 114 via SMSCs, MMSCs, or any other gateway interfacing or other means necessary for the appropriate routing of one or more communications 105 to mobile device A 104 and/or mobile device B 108. Message handling component 124 may further communicate with one or more other components of the present embodiment as is necessary or useful for the transmission of communications 105 and/or one or more web pages 118 to one or more mobile devices. For example and without limitation, message handling component 124 may coordinate the operations of web server 126. It is contemplated that mobile device A 104 and mobile device B 108 may be associated with different wireless carriers.

As shown in FIG. 1, server 111 further includes administration component 125. An administrator of a messaging service provider which operates the present embodiment may access administration component 125 via a laptop computer, mobile device, or any other device capable of Internet access. Upon accessing administration component 125, the administrator may modify, edit, delete or otherwise alter any data which is stored at web page store 116, data store 117, and/or any other data storage component at server 111.

In the embodiment shown in FIG. 1, server 111 further includes web server 126. Upon the occurrence of certain events more fully described below, web server 126 retrieves one of web pages 118 from web page store 116 and causes the retrieved web page to be transmitted to a mobile device, such as mobile device A 104.

As shown in FIG. 1, server 111 further includes wireless carrier communication component 127, which is capable of causing data (including but not limited to one or more communications directed to one or more mobile devices) to be transmitted to one or more wireless carriers, such as wireless carrier A 112 and wireless carrier B 114. Server 111 further includes network protocol component 128, which is capable of sending data to and receiving data from one or more devices connected to the Internet 110, such as mobile device A 104 and/or mobile device B 108.

Briefly stated, as shown in the embodiment described in FIG. 1, first user 102 may receive a sticker 106, which bears an ID number. First user 102 may use mobile device A 104 to transmit user registration data (including, for example and without limitation, the ID number and/or other data provided on first user 102′s sticker 106) to server 111 via the Internet 110. The user registration data transmitted to server 111 by first user 102 may also include the telephone number associated with mobile device A 104, and may further include additional user registration data, such as first user 102′s name and email address. Registration component 123 at server 111 may then store first user 102′s user registration data at data table 121 on data store 117. Upon first user 102's registration of mobile device A 104, message handling component 124 may generate communication 105 and cause communication 105 to be transmitted to mobile device A 104 via wireless carrier A 112. After first user 102 responds to communication 105 to confirm registration of mobile device A 104, first user 102 may communicate with server 111 via mobile device A 104, as more fully described below, to cause another communication to be transmitted to mobile device B 108 which is associated with second user 103.

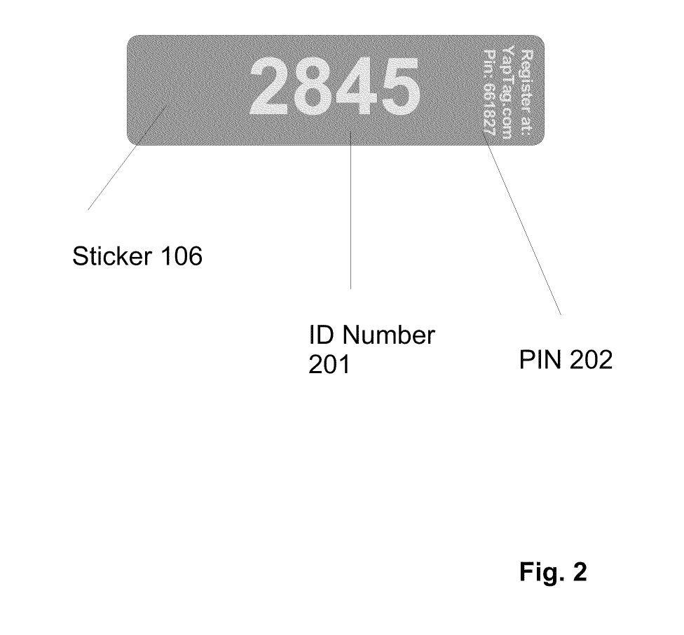

Turning now to FIG. 2, there is shown one implementation of sticker 106 as introduced in FIG. 1. In the example shown, ID number 201 appears in a large font to maximize its visibility to individuals in venue 101. Here, ID number 201 is the number “2845”. It is contemplated that in connection with the present embodiment, venue 101 will receive one or more stickers 106 from a messaging service provider in connection with a temporary social network 129, which one or more stickers 106 are referred to herein as a “batch”. A “batch” as used herein, and with respect to this embodiment, refers to a group of one or more stickers 106 which are associated with a venue 101 in connection with a single instance of a temporary social network 129. The ID numbers 201 associated with each batch of stickers 106 cease to operate after a period of limited duration, i.e., users who attempt to send communications 105 after the period of limited duration through the use of ID numbers 201 associated with the batch of stickers 106, find they can no longer use the ID numbers 201 to send communications 105.

For each batch of one or more stickers, each ID number 201 on each sticker 106 is unique, i.e., whenever venue 101 receives a batch of one or more stickers, no ID number 201 will be repeated within that batch. However, one or more identical ID numbers 201 may appear within one or more different batches of stickers provided to one or more different venues. For example and without limitation, the ID number “4545” may appear in one batch of stickers provided to the “Limelight Club” and may also appear in a different batch of stickers provided to the “Dew Drop Inn”, but that number will not appear more than once in a single batch of stickers provided to one venue.

In the embodiment shown, sticker 106 further includes a personal identification number (“PIN”) 202 which an individual, such as first user 102, may use in connection with ID number 201, the telephone number associated with mobile device A 104, and/or other data for transmission to registration component 123 as user registration data. In the embodiment shown, PIN 202 is the number “661827.” It is contemplated that stickers may be delivered to venues via messenger, postal delivery, electronic transmission, or any other delivery means. In one embodiment, electronic transmission of stickers may include enabling a venue manager to print one or more stickers on material with an adhesive backing.

It is contemplated that one embodiment allows a messaging service provider to create a duration-limited temporary social network 129 at a venue 101. The duration of the temporary social network 129 thereby created may, for example, be for a period of fifteen hours, after which the exchange of communications 105 through use of the ID numbers 201 provided via the stickers 106 (which were included in the venue 101's most recent batch) is no longer possible. However, in another embodiment, the temporary social network 129 may be operative for a longer time period, perhaps indefinitely. One or more users of this embodiment (such as first user 102 and second user 103) may wear one or more stickers 106, and may be able to use the ID numbers 201 associated with one or more stickers 106 to send one or more communications 105 to one another for a long period of time, perhaps even permanently.

In the embodiment shown, each ID number 201 is a four-digit number. In this embodiment, ID numbers which begin with the numeral 1, 2, 3, or 4 denote a male individual, such as first user 102. In this embodiment, ID numbers which begin with the numeral 5, 7, 8, or 9 denote a female individual, such as second user 103. Further, in this embodiment, each PIN 202 is a six-digit number. In this embodiment, no two stickers 106 have the same PIN 202, regardless of whether the stickers are in the same batch or not.

It is contemplated that other embodiments may use ID numbers 201 and PINs 202 with different numbers of digits—by way of example and without limitation, in a further embodiment, five-digit ID numbers 201 and seven-digit PINs 202 may be used.

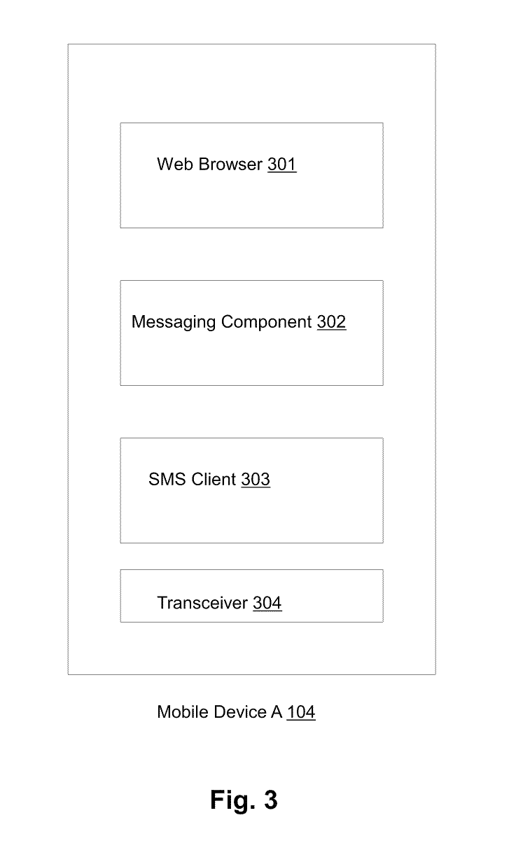

FIG. 3 depicts in a functional block diagram an embodiment of a mobile device, such as mobile device A 104, configured in accordance with one embodiment. In this embodiment, mobile device A 104 includes a mechanism for receiving one or more communications 105 and/or one or more web pages 118. The receiving mechanism is shown in this particular embodiment as transceiver 304 (for example, an RF radio transceiver), but may be any mechanism capable of receiving one or more communications 105 and/or one or more web pages 118. Alternatively, the mobile device (such as mobile device A 104) may include one mechanism capable of receiving one or more communications 105 and another mechanism capable of receiving one or more web pages 118.

Mobile device A 104 further includes a web browser 301 capable of rendering one or more web pages 118, a messaging component 302, and a SMS client 303 capable of receiving and/or displaying one or more communications 105. In the event communications 105 are not in the form of SMS, MMS, or EMS messages, SMS client 303 may be any combination of hardware, software, and/or firmware capable of receiving and/or displaying communications 105. Messaging component 302 enables the exchange of data between web browser 301 and SMS client 303. In one aspect, web browser 301 and SMS client 303 may be configured to communicate directly with each other without messaging component 302. In that case, messaging component 302 may be absent.

When transceiver 304 receives a web page 118 from web server 126, messaging component 302 may cause the web page 118 to be rendered via web browser 301. Alternatively, web browser 301 may receive the web page 118 directly from transceiver 304 and may render the web page 118.

When transceiver 304 receives a communication 105 from message handling component 124, messaging component 302 may cause the communication 105 to be displayed via SMS client 303. Alternatively, SMS client 303 may receive the communication 105 directly from transceiver 304 and may display the communication 105. In another aspect, communication 105 may be rendered by web browser 301.

FIGS. 4A through 4L illustrate representative implementations of web pages 118 introduced in conjunction with FIG. 1. It is to be understood that one or more web pages 118 may permit an individual to enter content, click on a link, or perform one or more other actions which cause the individual's device (i.e., one of the following depending on context: a mobile device such as mobile device A 104, a manager device 107, or a computer used by the administrator of a messaging service provider) to communicate with one or more components on server 111.

FIG. 4A illustrates registration page 401, which may be accessed by a user, for example and without limitation first user 102, who activates web browser 301 at mobile device A 104 and accesses registration page 401 at a website available at a URL such as <www.yaptag.com>. First user 102 reads ID number 201 and PIN 202 on his own sticker 106. First user 102 enters his ID number 201 into ID number entry field 403. First user 102 enters his PIN 202 into PIN entry field 404. First user 102 enters the telephone number associated with mobile device A 104 into telephone number entry field 405. First user 102 clicks join button 406. In this embodiment, user registration data includes ID number 201, PIN 202, and the telephone number associated with mobile device A 104. When the first user 102 clicks join button 406, the user registration data is transmitted to server 111 and stored in user data table 121.

FIG. 4A further illustrates welcome page 402. Welcome page 402 may be rendered by web browser 301 when the user, in this case first user 102, clicks join button 406. Alternatively, welcome page 402 may be rendered when the user confirms registration as discussed in further detail below.

FIG. 4B illustrates send message page 407, which permits first user 102 to cause a communication 105 to be transmitted to mobile device B 108 associated with second user 103. First user 102 views the ID number 201 on the sticker 106 worn by second user 103, and enters second user 103's ID number 201 in target ID number entry field 409. First user 102 enters content in message entry field 410, and clicks send button 411, thereby causing the content to be transmitted to server 111. At server 111, message handling component 124 may identify first user 102 from data included in a hyperlink URL associated with send button 411, by matching the telephone number associated with mobile device A 104 with first user 102's ID number 201 and/or PIN 202 in user data table 121, or by any other process capable of identifying first user 102 and/or verifying the registration of mobile device A 104. At server 111, the content is received by network protocol component 128. Message handling component 124 receives the content and generates a communication 105 containing the content. Wireless carrier communication component 127 receives the communication 105 and causes the communication 105 to be transmitted to mobile device B 108. At mobile device B 108, the communication 105 is received by the transceiver 304 associated with mobile device B 108 and displayed via the SMS client associated with mobile device B 108. In the event second user 103 has not registered mobile device B 108, server 111 may keep the communication 105 in a queue at message handling component 124. Subsequently, in the event mobile device B 108 is registered, message handling component 124 may cause the communication 105 to be transmitted to mobile device B 108. Alternatively, the communication 105 may be kept in a queue at a SMSC, MMSC, or other location capable of causing the communication 105 to be transmitted to mobile device B 108 after mobile device B 108 is registered at server 111.

After the user clicks send button 411 at send message page 407, web browser 301 may cause to be rendered a web page 118 which contains the phrase “message sent.” It should be understood that upon the entry of an ID number 201 into target ID number entry field 409, server 111 will search only for the identical ID number 201 registered to a mobile device associated with an individual at venue 101, and will not search for individuals with identical ID numbers 201 at different venues.

FIG. 4B further illustrates modify settings page 408, which allows the user to designate whether the user desires to receive messages from male or female individuals (the “user's preference”). If a user, in this example first user 102, clicks on either opposite sex entry field 412 or same sex entry field 413, then clicks update button 414, mobile device A 104 communicates first user 102′s preference to server 111, where first user 102's preference is stored in the portion of user data table 121 associated with first user 102. Consequently, when a communication 105 designated for first user 102 is received at server 111, message handling component 124 may permit the communication 105 to be transmitted to mobile device A 104 if the communication 105 originates from a mobile device registered by a member of the preferred gender. Message handling component 124 may block communications 105 which originate from a mobile device registered by a member of the non-preferred gender. Alternatively, administration component 125 may block or transmit communications 105 in accordance with the user's preference.

FIG. 4C illustrates cancellation page 415, which may allow a user to cancel the registration of the mobile device associated with that user. For example, if first user 102 accesses cancellation page 415 and clicks on cancel link 416, mobile device A 104 will cease to be registered, and will no longer be able to transmit and receive communications 105 at the venue 101 for which first user has registered mobile device A 104. More specifically, the act of clicking on cancel link 416 will cause message handling component 124 and/or registration component 123 at server 111 to modify user data table 121 in a manner which indicates mobile device A 104 is no longer registered at venue 101 for temporary social network 129. The cancellation of a mobile device registration pertains only to one instance of a temporary social network 129 in accordance with the present embodiment. For example and without limitation, if a venue 101 provides one batch of one or more stickers 106 to one or more users on one occasion, and first user 102 subsequently registers mobile device A 104 with the temporary social network 129 thereby created and then cancels that registration, first user 102 may later register mobile device A 104 with a different temporary social network 129, either at the same venue 101 or at a different venue.

After the user clicks on cancel link 416, web browser 301 may render a web page 118 containing the message “Cancellation confirmed, if you'd like to join again just go to www.YapTag.com” or a similar message.

FIG. 4C further illustrates reply page 417. Reply page 417 provides a check messages link 418 which, when clicked on, enables a user such as first user 102 to check for communications 105 which other users (for example, second user 103) have transmitted to first user 102. Reply page 417 further includes a check sent messages link 420 which, when clicked on, enables a user such as first user 102 to review the communications 105 that user (in this case, first user 102) has sent to other users, such as second user 103. The settings link 419 at reply page 417 causes web browser 301 to render modify settings page 408.

Reply page 417 further includes message display field 421, which displays a communication 105 received in accordance with the present embodiment. When the user clicks on send message link 427, web browser 301 renders send message page 407.

The user may also click on block link 423, which causes server 111 to block further messages from the blocked user to the blocking user for the duration of the temporary social network 129. For example, if second user 103 receives a communication 105 from first user 102 and clicks block link 423 in connection with the communication 105 from first user 102, server 111 will block mobile device B 108 from receiving any further messages from mobile device A 104 for the duration of the temporary social network 129.

The user may further click on flag link 424, which may cause server 111 to record an instance of flagging in connection with the flagged user at user data table 121. For example, if second user 103 flags first user 102, one instance of flagging of first user 102 may be recorded at user data table 121. Server 111 may be configured to terminate the registration of the mobile device associated with first user 102 (or any other user in a similar position) when user data table 121 indicates first user 102 has exceeded a permitted number of instances of flagging. After the user clicks on flag link 424, web browser 301 may render a web page 118 which contains the message “Thanks, if we get many flags for this person their account will be disabled” or a similar message.

FIG. 4D illustrates inbox page 425, which displays the one or more communications 105 received by a user at that user's mobile device, in this case mobile device A 104 associated with first user 102. The check sent messages link allows first user 102 to cause a web page 118 to be rendered which displays the one or more communications 105 first user 102 has sent to one or more other users. (See outbox page 426, described below.) Clicking on settings link 419 causes web browser 301 to render modify settings page 408. When the user clicks on send message link 427, web browser 301 renders send message page 407. When the user clicks on refresh link 422, mobile device A 104 queries server 111 for recent communications 105 directed to mobile device A 104, and web browser 301 re-renders inbox page 425 to display any additional communications 105 which have recently been received at mobile device A 104.

In this embodiment, inbox page 425 further includes a check sent messages link 461 which, when clicked on, enables a user such as first user 102 to review the communications 105 that user (in this case, first user 102) has sent to other users, such as second user 103. Clicking on settings link 463 causes web browser 301 to render modify settings page 408. When the user clicks on send message link 462, web browser 301 renders send message page 407.

In this embodiment, inbox message list field 428 displays one or more communications 105 received at mobile device A 104 with the most recent at the top and the least recent at the bottom, in descending order of time received. Inbox message list field 428, in one embodiment, only displays one communication 105 per user; for example, if second user 103 has sent more than one communication 105 to first user 102, inbox message list field 428 will nevertheless display only one communication 105 from second user 103 (the most recent one). In the embodiment shown, when first user 102 clicks on new message link 429—which in the illustrated case is the displayed text associated with a communication 105 sent by second user 103 (“Some text of last message” as shown on FIG. 4D), web browser 301 renders display page 460.

FIG. 4E illustrates display page 460. In the embodiment shown, display page 460 displays a series of communications 105 transmitted from second user 103 to first user 102, as well as the communications 105 transmitted from first user 102 to second user 103. When the user, in this case first user 102, clicks on one of the send message links 464, web browser 301 renders send message page 407.

The user may also click on block link 466, which causes server 111 to block further messages from the blocked user to the blocking user for the duration of the temporary social network 129. For example, if second user 103 receives a communication 105 from first user 102 and clicks block link 466 in connection with the communication 105 from first user 102, server 111 will block mobile device B 108 from receiving any further messages from mobile device A 104 for the duration of the temporary social network 129.

The user may further click on flag link 465, which may cause server 111 to record an instance of flagging in connection with the flagged user at user data table 121. For example, if second user 103 flags first user 102, one instance of flagging of first user 102 may be recorded at user data table 121. Server 111 may be configured to terminate the registration of the mobile device associated with first user 102 (or any other user in a similar position) when user data table 121 indicates first user 102 has exceeded a permitted number of instances of flagging. After the user clicks on flag link 465, web browser 301 may render a web page 118 which contains the message “Thanks, if we get many flags for this person their account will be disabled” or a similar message.

FIG. 4F illustrates outbox page 426. In the embodiment shown, clicking on check message link 467 causes web browser 301 to render inbox page 425. Clicking on settings link 469 causes web browser 301 to render modify settings page 408. When the user clicks on send message link 468, web browser 301 renders send message page 407. In this embodiment, outbox message list field 430 displays one or more communications 105 transmitted from mobile device A 104 with the most recent at the top and the least recent at the bottom, in descending order of the time transmitted. Clicking on the displayed text of a sent message may cause web browser 301 to render a display page 460 which displays one or more messages exchanged between first user 102 and the user to whom the displayed text was sent, for example second user 103.

FIG. 4G illustrates administration page 431. In this embodiment, administration page 431 allows an administrator of a messaging service provider, for example and without limitation YapTag, to add a venue 101 to venue data table 122 by clicking on add venue link 432. The administrator may also modify or add one or more stickers 106 to venue data table 122 in connection with a venue 101, after entering the relevant code for venue 101 in search venue field 435 and clicking on modify stickers link 433. (The administrator may repeat the process for any venue which chooses to register with the present embodiment.) The adminstrator may obtain relevant venue statistics by entering the relevant code for a venue 101 in search venue field 435, then clicking on venue statistics link 434.

FIG. 4H illustrates add venue page 436. Add venue page 436 may be rendered when the administrator clicks on add venue link 432. Add venue page 436 provides venue data entry fields 437. When the administrator enters the relevant data into venue data entry fields 437 and clicks add venue button 438, server 111 may cause the data so entered to be added to the fields within venue data table 122 which are associated with the administrator's selected venue.

FIG. 4I illustrates add sticker page 439, which may be rendered when the administrator clicks on modify stickers link 433. Batch name entry field 440 allows the administrator to enter a batch name (or alternatively, a number or other designation) associated with a batch of stickers 106, which batch the administrator wishes to associate with a particular venue 101. When the administrator clicks batch add button 441, server 111 may cause the data associated with the designated batch (for example and without limitation, a range of ID numbers 201 and PINs 202) to be added to the fields within venue data table 122 which are associated with the administrator's selected venue. In the alternative, clicking batch add button 441 may cause add sticker data page 442 to be rendered.

FIG. 4J illustrates add sticker data page 442. Add sticker data page 442 may display the identifying data (as illustrated, ID numbers 201 and PINs 202) associated with the administrator's designated batch of stickers 106. The administrator may use batch data entry field 443 to edit the identifying data displayed within batch data entry field 443, for example by manually pasting in additional ID numbers 201 and PINs 202 associated with other stickers 106 which the administrator wishes to associate with a venue 101. Once the administrator has edited the identifying data, the administrator may click save data button 444, whereupon server 111 will cause the identifying data to be stored in the portion of venue data table 122 associated with the venue 101.

FIG. 4K illustrates venue login page 445, which may be rendered in a web browser at manager device 107. The manager of venue 101, which is registered at server 111, may access data pertaining to venue 101 by accessing venue login page 445 at manager device 107. Venue login data entry field 446 allows the manager to communicate with server 111 via manager device 107 and to confirm the manager's permission to access the requested data by providing the required information, in this case a user name, password, and captcha. Used sticker display field 447 indicates the number of stickers 106 which have been used by venue 101. Remaining sticker display field 448 indicates the number of stickers 106 which remain unused and which are associated with venue 101. Send guest message link 449 enables the manager to cause a communication 105 to be transmitted to one or more individuals who have registered their mobile devices at the manager's venue 101. Clicking on block guest link 450 allows the manager to prevent a designated individual from registering the designated individual's mobile device through the use of any ID number 201 and/or PIN 202 which appear on any sticker 106 associated with venue 101.

FIG. 4L illustrates venue SMS page 451, which may be rendered at manager device 107 when the manager of venue 101 clicks on send guest message link 449. A “customer” of venue 101, as used in connection with this embodiment, means a user who has registered a mobile device which is associated with the user (for example, first user 102 who has registered mobile device A 104) with server 111 through the use of an ID number 201 and/or PIN 202 appearing on a sticker 106 associated with venue 101. Venue SMS page 451 displays, via female registration display field 452, the number of female customers of venue 101. Similarly, at male registration display field 453, there is displayed the number of male customers of venue 101.

A “customer mobile device”, as used in connection with this embodiment, means a mobile device associated with a customer of venue 101. It is contemplated that user registration data associated with customer mobile devices may be retained in data table 121 for an indefinite period, during which a manager may cause one or more communications to be transmitted to one or more customer mobile devices. In one embodiment, customer mobile devices registered with server 111 are enabled to opt out of receiving one or more communications from venue managers who wish to send them communications.

In the embodiment shown, the manager may click on the female message choice field 454 to indicate a desire to send a communication to all customer mobile devices associated with female customers of venue 101. Alternatively, the manager may click on the male message choice field 455 to indicate a desire to send a communication to all customer mobile devices associated with male customers of venue 101. In another alternative, the manager may enter a number into female number entry field 456, thereby indicating a desire to send a communication to the designated number of customer mobile devices associated with female customers of venue 101. In yet another alternative, the manager may enter a number into male number entry field 457, thereby indicating a desire to send a communication to the designated number of customer mobile devices associated with male customers of venue 101.

The manager enters the desired content into venue message entry field 458, then clicks the venue send button 459 to cause the desired content to be sent to the customer mobile devices associated with the designated customers as a SMS message or other communication. Server 111 accesses data tables 120 to determine which customer mobile devices should receive the communication. For example and without limitation, server 111 may access data tables 120 to determine which female users registered their mobile devices using data on stickers 106 associated with venue 101. After the manager clicks venue send button 459, server 111 may cause the web browser at manager device 107 to render the message “successfully sent” or a similar message.

It should be understood that the illustrative web pages 118 discussed herein are representative web pages, and any other web pages, or combinations of them, may be used with any combination of the functionalities and/or content described herein.

FIG. 5A illustrates one implementation of the user data table 121 introduced in conjunction with FIG. 1. Each row of data within user data table 121 is associated with one user—for example, the top row of the user data table 121 illustrated in FIG. 5A contains data relating to first user 102. Each column within user data table 121 contains data of a particular type—for example, the leftmost column of the user data table 121 illustrated in FIG. 5A contains ID numbers 201. As illustrated, other columns contain PINS 502, telephone numbers 503, and additional data 504. Each of telephone numbers 503 is associated with a mobile device registered with server 111 in accordance with the present embodiment. It is contemplated that, in one embodiment, each of telephone numbers 503 will be kept confidential by the administrator of the messaging service provider and will not be shared with the managers of venues or with users other than the user whose mobile device is associated with that telephone number 503. For example and without limitation, the telephone number 503 associated with mobile device A 104, which is used by first user 102, would not be shared with second user 103 or with the manager of venue 101.

As illustrated, each row within additional data 504 indicates the gender of the user with whom that row is associated. In the illustrated example, additional data 504 indicates that first user 102 is a male. As illustrated, the first row in user data table 121 indicates that the ID number associated with first user 102 (as provided on the sticker 106 given to first user 102 by venue 101) is “2845”, the PIN associated with first user 102 is “661827”, and the telephone number associated with mobile device A 104 (which is the mobile device used by first user 102) is “2128675309”. It is contemplated that additional data 504 may contain any and all other data which is necessary or desirable to facilitate the operation of the present embodiment. It is further contemplated that additional data 504 may take the form of one or more columns within user data table 121.

FIG. 5B illustrates one implementation of the venue data table 122 introduced in conjunction with FIG. 1. Each row of data within venue data table 122 is associated with one venue—for example, the top row of the venue data table 122 illustrated in FIG. 5A contains data relating to venue 101. Each column within venue data table 122 contains data of a particular type—for example, the leftmost column of the venue data table 122 illustrated in FIG. 5B contains venue names 505. As illustrated, other columns contain contact persons 506, email addresses 507, and additional venue data 508.

In the illustrated embodiment, the topmost row of venue data table 122 contains data associated with venue 101. As illustrated in FIG. 5B, the top row within additional venue data 508 contains ID numbers 201 and PINs 202 associated with the stickers 106 provided to venue 101. It is to be understood that although the additional venue data 508, as illustrated in FIG. 5B, is shown in a single row or cell, the additional venue data 508 may alternatively reside in plural rows and/or cells.

It is contemplated that additional venue data 508 may contain any and all other data which is necessary or desirable to facilitate the operation of the present embodiment. It is further contemplated that additional venue data 508 may take the form of one or more columns within venue data table 122. In another aspect, for each venue 101, additional venue data 508 may take the form of one or more rows within venue data table 122, in which case each venue 101 would be associated with one or more rows within venue data table 122.

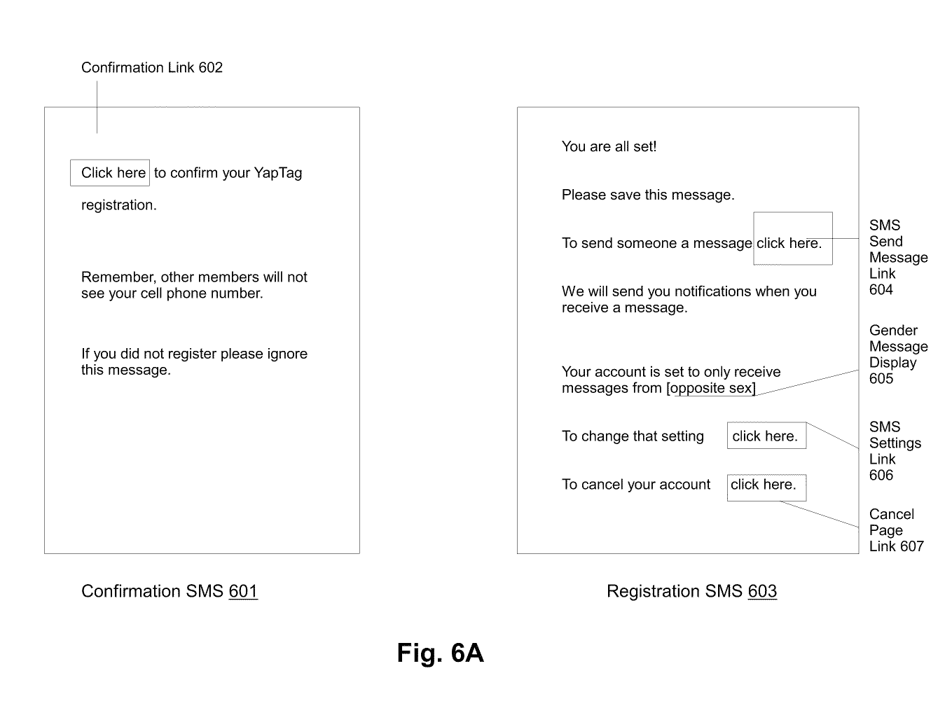

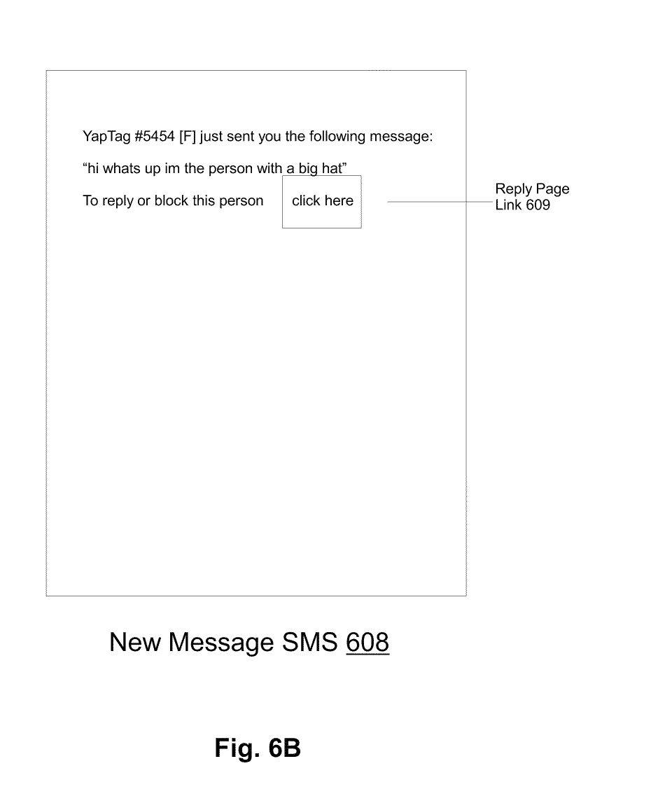

FIGS. 6A and 6B illustrate representative implementations of communications 105 introduced in conjunction with FIG. 1. FIG. 6A illustrates confirmation SMS 601. Confirmation SMS 601 is generated and is transmitted to SMS client 303 at a mobile device (in this example mobile device A 104) after a user (in this example first user 102) enters the user registration data at registration page 401 and transmits the user registration data to server 111. When first user 102 clicks confirmation link 602 provided within confirmation SMS 601, a confirmation notice is transmitted from mobile device A 104 to server 111. Message handling component 124 causes web server 126 to retrieve welcome page 402. Web server 126 causes welcome page 402 to be transmitted to mobile device A 104. Welcome page 402 may be rendered via the web browser 301 at mobile device A 104. Registration SMS 603, which is illustrated in FIG. 6A, may also be received at mobile devicregistration smse A 104 and displayed via SMS client 303.

In this embodiment, confirmation link 602 is associated with a hyperlink URL which may be identical or similar to the following: <http://yaptag.com/conf_reg?/UID=2845661827>, in which “yaptag.com” identifies the particular Internet domain name associated with server 111, “conf reg?” indicates the requesting user wishes to confirm registration of the requesting user's mobile device, and “UID=2845661827” identifies the requesting user by the requesting user's ID number 201 and PIN 202. Alternatively, the hyperlink URL provided by confirmation link 602 may be in the following form: <http://yaptag.com/conf/8798798iuhe9879> or any other form capable of indicating to registration component 123 that the requesting user desires to confirm the registration of the requesting user's mobile device.

In this embodiment, when a user clicks on confirmation link 602, that causes the user's mobile device, in this example mobile device A 104, to transmit a confirmation notice to registration component 123 at server 111, via transceiver 304, indicating that the user (here, first user 102) wishes to confirm the registration of the user's mobile device. Registration component 123 causes message handling component 124 to generate registration SMS 603. Message handling component 124 causes registration SMS 603 to be transmitted to SMS client 303 via transceiver 304. SMS client 303 displays registration SMS 603. Alternatively, registration SMS 603 may be transmitted to SMS client 303 upon the user's transmission of user registration data from a mobile device (such as mobile device A 104) to server 111 via registration page 401 or a similar web page. In that case, the steps of generating a confirmation SMS, causing the confirmation SMS to be transmitted to the mobile device, and receiving a confirmation notice from the mobile device, would be unnecessary.

FIG. 6A further illustrates registration SMS 603. Registration SMS 603 includes SMS send message link 604. Clicking on SMS send message link 604 causes web browser 301 to render send message page 407. In this embodiment, SMS send message link 604 is associated with a hyperlink URL which may be identical or similar to the following: <http://yaptag.com/send mesg?/UID=2845661827>, in which “yaptag.com” identifies the particular Internet domain name associated with server 111, “send_mesg?” indicates the requesting user wishes to send a communication 105 to another user, and “UID=2845661827” identifies the requesting user by the requesting user's ID number 201 and PIN 202. Alternatively, the hyperlink URL provided by SMS send message link 604 may be in any other form capable of being mapped to send message page 407 or otherwise causing web browser 301 to render send message page 407. It is to be understood that a similar analysis of hyperlink URLs may apply to any other hyperlink URLs included within the present embodiment.

Registration SMS 603 further includes gender message display 605, which indicates the preferred gender of individuals from whom the user wishes to receive one or more communications 105. In one embodiment, the default setting may be to cause each user (in this example, first user 102) to receive communications 105 only from the opposite gender, unless first user 102 changes his settings to indicate a desire to receive communications 105 from the same gender.

Registration SMS 603 further includes SMS settings link 606. When a user (for example, first user 102) clicks on SMS settings link 606, web browser 301 renders modify settings page 408. Registration SMS 603 also includes cancel page link 607. When a user (for example, first user 102) clicks on cancel page link 607, web browser 301 renders cancellation page 415.

FIG. 6B illustrates new message SMS 608. When a user (in this example, first user 102) receives a new communication 105 from another user (in this example, second user 103) at server 111, message handling component 124 generates new message SMS 608 and causes it to be transmitted to mobile device A 104 and displayed via SMS client 303. New message SMS 608 includes reply page link 609. When a user (for example, first user 102) clicks on reply page link 609, web browser 301 renders reply page 417.

It should be understood that the implementations of communications 105 illustrated in FIGS. 6A and 6B are merely representative, and any other communications 105, or combinations of them, may be used with any combination of the functionalities and/or content described herein.

It is also contemplated that in other embodiments, the present system, method, and product may be used to transmit telephone messages, video messages, email messages, and any other form of messages which are capable of being transmitted via a mobile device.

FIG. 7 illustrates in greater detail one implementation of the server 111 introduced in conjunction with FIG. 1. Registration component 123, message handling component 124, administration component 125, web server 126, web page store 116, and data store 117 have been described above in conjunction with FIG. 1. Carrier communication backbone 701 permits server 111 to send data to and/or receive data from a mobile device (for example, mobile device A 104) via a wireless carrier (for example, wireless carrier A 112). Carrier communication backbone 701 may be one or more networks and/or one or more components of networks capable of sending data to and receiving data from one or more wireless carriers, for example and without limitation, one or more GSM networks, one or more CDMA networks, one or more public switched telephone networks (PSTNs), one or more mobile switching centers (MSC), and one or more radio base stations (RBS's). Wireless carrier communication component 127 may be any software, hardware and/or firmware component capable of communicating with carrier communication backbone 701, including but not limited to a GSM modem, a GPRS modem, an RF transceiver, and the like. It is to be understood that wireless carrier communication component 127 transmits data to and receives data from carrier communication backbone 701 as needed by other components at server 111.

As further indicated in FIG. 7, network protocol component 128 permits server 111 to send data to and receive data from a mobile device (for example, mobile device A 104) via the Internet 110. Network protocol component 128 may include any hardware, software, and/or firmware component capable of communicating with the Internet 110. The present method, system, and product are contemplated for use with any communication network, and with any method or technology which may be used to communicate with said network, including without limitation the Internet, wireless fidelity networks, TCP/IP wide-area networks, and the like. It is to be understood that network protocol component 128 transmits data to and receives data from the Internet 110 as needed by other components at server 111.

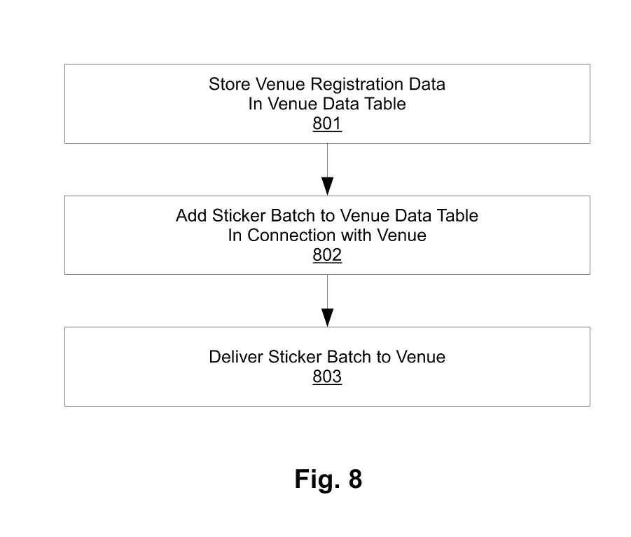

In FIG. 8, by way of an operational flow diagram, there is depicted another embodiment of the present communication method, product, and system. As shown, at step 801, venue registration data for venue 101 may be received at server 111 via registration component 123 and stored in venue data table 122 on data store 117. A manager of venue 101 may transmit the venue registration data to server 111 via manager device 107. In another aspect, an administrator of a messaging service provider may add venue registration data directly to venue data table 122. At step 802, a batch of one or more stickers 106 is selected and the data which is associated with the batch of one or more stickers 106 (“identifying data”) (for example and without limitation, a range of ID numbers 201 and PINs 202) is added to the fields within venue data table 122 which are associated with venue 101. At step 803, the selected batch of one or more stickers 106 are delivered to venue 101.

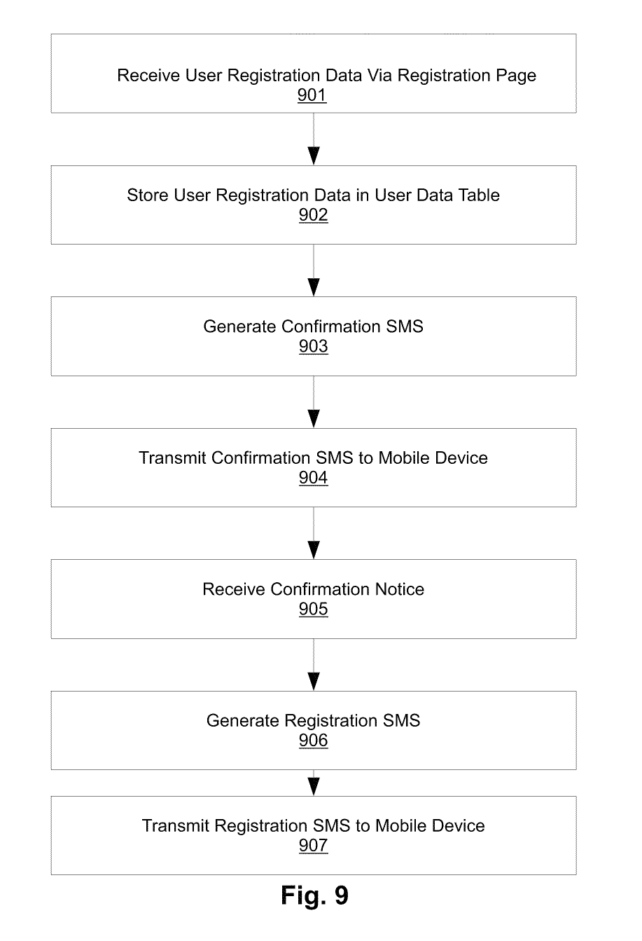

In FIG. 9, by way of an operational flow diagram, there is depicted another embodiment of the present communication method, product, and system. In the embodiment shown, at step 901, user registration data associated with a mobile device (in this example, mobile device A 104) is received by registration component 123 at server 111. Without limitation, the user registration data may be the ID number 201 and PIN 202 from the sticker 106 worn by first user 102, as well as the telephone number associated with mobile device A 104, transmitted to registration component 123 when first user 102 enters the user registration data at registration page 401 via web browser 301 and clicks join button 406. It is contemplated that in the embodiment shown, first user 102 has received sticker 106 at venue 101, that venue 101 has been registered with a temporary social network 129, and that venue 101 has been provided with a batch of stickers 106 which are associated with venue 101 in venue data table 122. In another aspect, registration component 123 may perform operations necessary to verify the accuracy of all or part of the user registration data.

At step 902, registration component 123 stores the user registration data in user data table 121. In one aspect, registration component 123 may refer to user data table 121 and venue data table 122 to determine the venue 101 associated with the temporary social network 129 for which first user 102 wishes to register mobile device A 104. In another aspect, the data associated with first user 102 in user data table 121 may include identification of venue 101 associated with temporary social network 129. It is contemplated that in this embodiment, each set of user registration data received by registration component 123 will be unique—for example and without limitation, registration component 123 will not receive twice the same combination of an ID number 201, a PIN 202, and a telephone number associated with a mobile device.

At step 903, registration component 123 causes message handling component 124 to generate confirmation SMS 601. At step 904, message handling component 124 causes confirmation SMS 601 to be transmitted to mobile device 904. At step 905, registration component 123 receives a notice that first user 102 wishes to confirm the registration of mobile device A 104. This may occur when first user 102 clicks confirmation link 602 provided within confirmation SMS 601. At step 906, registration component 123 causes message handling component 124 to generate registration SMS 603. At step 907, message handling component 124 causes registration SMS 603 to be transmitted to mobile device A 104. In another aspect, at step 907, message handling component 124 may cause web server 126 to retrieve welcome page 402 from web page store 116, and web server 126 may cause welcome page 402 to be transmitted to mobile device A 104 for rendering via web browser 301.

In another aspect, registration component 123 may cause message handling component 124 to generate registration SMS 603, and message handling component 124 may transmit registration SMS 603 to mobile device A 104, without requiring confirmation of the registration of mobile device A 104.

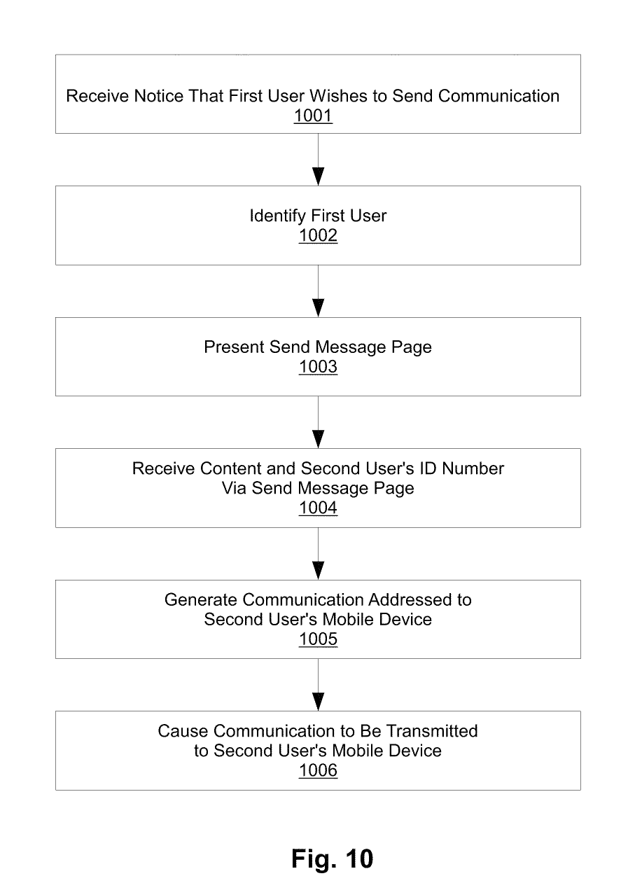

In FIG. 10, by way of an operational flow diagram, there is depicted another embodiment of the present communication method, product, and system. In the embodiment shown, at step 1001, message handling component 124 at server 111 receives a notice that a first user 102 requests to send a communication 105 to a second user 103. In one aspect, message handling component 124 may receive this notice after first user 102 clicks SMS send message link 604 provided within registration SMS 603. In another aspect, message handling component 124 may receive this notice after the following events occur: first user 102 enters the ID number 201 associated with second user 103 into target ID number entry field 409 at send message page 407, first user 102 enters content into message entry field 410, and first user 102 clicks send button 411.

At step 1002, in the embodiment shown, message handling component 124 identifies first user 102 from data included in a hyperlink URL associated with SMS send message link 604. In another aspect, message handling component 124 may identify first user 102 by matching the telephone number associated with mobile device A 104 with first user 102′s ID number 201 and/or PIN 202 in user data table 121.

At step 1003, in the embodiment shown, message handling component 124 causes web server 126 to retrieve send message page 407 from web page store 116, and web server 126 causes send message page 407 to be transmitted to mobile device A 104 for presentation to first user 102 via web browser 301.

At step 1004, message handling component 124 receives content and an ID number associated with second user 103. In one aspect, message handling component 124 may receive the content and second user 103′s ID number upon the occurrence of the following events: first user 102 enters the ID number 201 associated with second user 103 into target ID number entry field 409 at send message page 407, first user 102 enters content into message entry field 410, and first user 102 clicks send button 411.

At step 1005, message handling component 124 generates a communication 105 addressed to second user 103′s mobile device B 108. In the embodiment shown, the communication 105 contains the content which first user 102 has entered into message entry field 410, which first user 102 requested be sent to second user 103 by way of entering second user 103′s ID number into target ID number entry field 409 and clicking send button 411. In one aspect, the communication 105 generated at step 1005 may be in the form of new message SMS 608. At step 1006, message handling component 124 causes the communication 105 to be transmitted to second user 103′s mobile device B 108.

The exchange of any messages which can be sent or received by way of a mobile communication device, through the Internet, or through any other electronic delivery means, is contemplated in conjunction with the present embodiment. Further, it is contemplated that the present invention may later be embodied within one or more downloadable applications which may be downloaded to users' mobile devices to facilitate use of the present inventive method, product and system.

As will be appreciated by those persons skilled in the art, the present inventive method, product and system, inclusive of one or more embodiments of its operation through software and hardware systems and the like, affords distinct business advantages not previously available to venues and/or individuals within those venues. For example and without limitation, many individuals find it difficult to approach strangers and engage them in conversation. An embodiment solves this problem by making it possible to view the ID number on another individual's sticker, register a mobile device with the system, and immediately begin exchanging SMS messages with that other individual regardless of which wireless carrier is associated with that other individual's mobile device.

The present invention also solves a problem many venues have—customer retention. By way of example and without limitation, a venue which is a nightclub may find it difficult to retain customers because there are other competing clubs nearby and the venue's customers are eager to explore them. However, if the venue provides stickers to its customers, and those customers register their mobile devices to use the present method, system, and product, the customers may wish to remain in the venue because of the increased opportunities for social interaction. The customers are likely to have a more positive experience, to meet interesting people, to buy more drinks (thereby increasing the venue's revenue), to return to the venue where they had the positive experience, and to recommend the venue to their friends and acquaintances.

Another advantage offered by the present method, system, and product is the ease of use and the ability of users to register quickly and receive SMS messages from other users almost immediately. Through use of the present method, system, and product, a user can enter a venue, obtain a sticker, transmit the required user registration data, and confirm registration within seconds. This may provide gratification which is almost immediate. The speed by which SMS messages may be transmitted from one user to another is also gratifying.

Privacy is another advantage conferred by the present method, system, and product. Users may communicate with one another without exchanging telephone numbers. Further, venue managers may communicate with their customers without having access to those customers' telephone numbers.

The present method, system, and product further avoids the need for venues to rely on promoters. Promoters can take a large percentage of the revenue generated by the efforts they make to convince customers to patronize the promoted venues. When a promoter ceases to promote a venue, that venue's customer base may dwindle, causing revenue to drop. Venue managers may avoid this scenario by making use of the present method, system, and product to encourage customers to patronize their venues.

Another advantage offered by the present method, system, and product is the time-limited duration of each temporary social network created thereby. Customers at a venue who are aware of the temporary nature of the social network may be encouraged to accelerate their use of the present method, system, and product, thereby maximizing the number of social contacts they make through the exchange of SMS messages.

While this invention has been described in connection with what are currently considered to be the most practical and desirable embodiments, it is to be understood that the invention is not limited to the disclosed embodiments in any way as such are merely set forth for illustrative purposes. The present inventive product and system and methods are intended to cover an array of various modifications and equivalent arrangements, all of which are contemplated for inclusion within the scope and spirit of the disclosure and appended claims.

What is claimed is:

1. A computer-implemented method for the creation of a temporary social network at a venue, comprising, in no particular order, the steps of:
configuring a server to facilitate the exchange of a communication between one or more mobile devices associated with one or more wireless carriers;
storing venue registration data for the venue in a venue data table at a data store, the data store being in communication with the server;
adding to the venue data table, in connection with the venue, identifying data associated with a batch of one or more stickers, each of the one or more stickers bearing an ID number, each ID number capable of identifying a user at the venue and further capable of being used to address a first communication to a mobile device associated with the user; and
delivering the one or more stickers to the venue.

2. The method of claim 1, wherein each of the one or more stickers further bears a PIN which permits registration via a registration component of a mobile device, the registration enabling the mobile device to transmit and receive one or more communications via a message handling component.

3. The method of claim 2, including storing user registration data for the one or more mobile devices, the user registration data being stored in a user data table at the data store, each of the one or more mobile devices being registered via the registration component.

4. The method of claim 1, including enabling a manager of the venue to cause an other communication to be transmitted to one or more customer mobile devices.

5. The method of claim 4, including enabling at least one of the one or more customer mobile devices to opt out of receiving the other communication from the manager of the venue.

6. The method of claim 1, wherein the communication is a SMS message.

7. A computer-readable medium having computer-executable instructions for performing the method of claim 1.

8. A computer-readable medium encoded with computer-executable instructions for facilitating the exchange of a SMS message between a first mobile device associated with a first user and a second mobile device associated with a second user, the instructions comprising, in no particular order:
receiving a notice that the first user wishes to transmit the SMS message to the second mobile device, the notice identifying the first user;
presenting a send message page to the first user, the send message page enabling the first user to enter content, the send message page further enabling the first user to enter an ID number associated with the second user;
receiving the content and the ID number associated with the second user;
generating the SMS message, the SMS message containing the content and being addressed to the second mobile device; and
causing the SMS message to be transmitted to the second mobile device.

9. The computer-readable medium recited in claim 8, the instructions further comprising, in no particular order:
receiving user registration data associated with the first user;
storing the user registration data associated with the first user in a user data table,
generating a registration SMS; and
causing the registration SMS to be transmitted to the first mobile device.

10. The computer-readable medium recited in claim 9, the instructions further comprising, in no particular order:
generating a confirmation SMS;
causing the confirmation SMS to be transmitted to the first mobile device; and
receiving a confirmation notice from the first mobile device.

11. The computer-readable medium recited in claim 8, including retaining the SMS message in a queue for later transmission to the second mobile device.

12. The computer-readable medium recited in claim 9, wherein the user registration data associated with the first user includes an ID number, a PIN, and a telephone number.

13. The computer-readable medium recited in claim 8, wherein the first mobile device and the second mobile device may be associated with different wireless carriers.

14. The computer-readable medium recited in claim 8, wherein the ID number associated with the second user is visibly displayed on a sticker worn by the second user at a venue.

15. A system for the creation of a temporary social network at a venue, comprising:
a data store, wherein the data store includes a user data table and a venue data table;
a web page store, wherein the web page store includes one or more web pages;
a registration component that (i) receives venue registration data and stores the venue registration data in the venue data table and (ii) receives user registration data from one or more mobile devices and stores the user registration data in the user data table;
a message handling component that generates a communication and causes the communication to be transmitted to a mobile device;
an administration component that enables the administrator of a messaging service provider to modify data which is stored at the data store;
a web server that retrieves one of the one or more web pages from the web page store and causes the retrieved web page to be transmitted to the mobile device;
a wireless carrier communication component that causes the communication to be transmitted to the mobile device via a wireless carrier; and
a network protocol component that transmits data to the mobile device via the Internet.

16. A system as recited by claim 15, wherein the venue data table includes identifying data associated with a batch of one or more stickers, each of the one or more stickers bearing an ID number, each ID number capable of identifying a user at a venue and further capable of being used to address the communication to a mobile device associated with the user.
